(19) United States
(12) Patent Application Publication
(10) Pub. No.: US 2010/0186427 A1
(43) Pub. Date: Jul. 29, 2010

(54) Exhaust system

(75) Inventors: Takahiro Okada, Minamitsuru-gu (JP); Tokumitsu Arai, Minamitsuru-gun (JP); Kazutoshi Aoki, Minamitsuru-gun (JP)

Correspondence Address: FITZPATRICK CELLA HARPER & SCINTO, 1290 Avenue of the Americas, NEW YORK, NY, 10104-3800, US

(73) Assignee: CANON ANELVA TECHNIX CORPORATION, Kawasaki-shi (JP)

(21) Appl. No.: 12/709,813

(22) Filed: Feb. 22, 2010

Related U.S. Application Data
(63) Continuation of application No. PCT/JP2008/065093, filed on Aug. 25, 2008.

(30) Foreign Application Priority Data
Aug. 28, 2007 (JP) 2007-220881

(51) Int. Cl. B01D 8/00; F25B 49/02

(52) U.S. Cl. 62/55.5; 62/228.1

(57) ABSTRACT

An exhaust system includes an entrapment vacuum pump equipped with a refrigerator, a master compressor which is driven in a driving frequency band to make constant a pressure difference between gas recovered from the refrigerator via a low-pressure gas recovery pipe and compressed gas supplied to the refrigerator via a high-pressure gas supply pipe, and a first sub-compressor which is driven at a predetermined driving frequency to supply compressed gas at a first gas volume to the refrigerator via a high-pressure gas supply pipe from gas recovered from the refrigerator via a low-pressure gas recovery pipe. In addition, a second sub-compressor is driven at a predetermined driving frequency to supply compressed gas at a second gas volume larger than the first gas volume to the refrigerator via a high-pressure gas supply pipe from gas recovered from the refrigerator via a low-pressure gas recovery pipe, and a controller monitors a driving frequency of the master compressor and controls driving or a stop of the first sub-compressor and driving or a stop of the second sub-compressor, based on the driving frequency.

This application is a continuation of PCT/JP2008/065093, filed Aug. 25, 2008.

### TECHNICAL FIELD

The present invention relates to an exhaust system including a plurality of compressors and a plurality of cryopumps.

### BACKGROUND ART

A conventional cryopump system will be described with reference to FIG. 4.

A cryopump system utilizes a refrigeration system formed from a refrigerator unit and compressor. The cryopump system performs vacuum pumping by condensing or absorbing gas at a cryogenic temperature generated by the refrigeration system. The refrigerator unit generates a cryogenic temperature, and the compressor supplies a compressed gas (for example, helium gas) to the refrigerator unit.

Equipment typified by a semiconductor manufacturing apparatus uses a plurality of cryopumps. In this case, a so-called multi-operating system is often employed to supply gas from one compressor to a plurality of cryopumps for the purpose of cost reduction and energy saving.

The arrangement of a cryopump system disclosed in patent reference 1 will be explained as an example of the arrangement of a conventional cryopump system.

The cryopump system in patent reference 1 includes cryopumps 103a to 103e, pressure sensors 102, and differential pressure control compressors 101a to 101c.

In the cryopump system, the pressure sensors 102 are attached to high-pressure gas supply pipes 104 and low-pressure gas recovery pipes 105. The high-pressure gas supply pipes 104 supply gas to refrigerators in the frequency control cryopumps 103a to 103e. The low-pressure gas recovery pipes 105 recover gas from the refrigerators in the frequency control cryopumps 103a to 103e.

The cryopumps 103a to 103e used in this specification may be of the frequency control type. The frequency control cryopump controls the driving frequency of a valve driving motor which controls the intake/exhaust cycle of the refrigerator mounted on the cryopump, based on an output from a temperature sensor attached to the refrigerator. Under this control, the temperature of the refrigerator can be kept constant, preventing excessive cooling and minimizing gas consumption of the refrigerator.

The differential pressure control compressors 101a to 101c include controllers capable of controlling the driving frequency of the compressor main body. The differential pressure control compressors 101a to 101c maintain a predetermined pressure difference between the high-pressure gas supply pipes 104 and the low-pressure gas recovery pipes 105 in accordance with outputs from the pressure sensors 102 attached to the low-pressure gas recovery pipes 105.

The cryopump system in patent reference 1 using a combination of these components tries to suppress power consumption of the differential pressure control compressor and save energy by supplying gas only at a volume necessary for the frequency control cryopump from the differential pressure control compressor.

Patent Reference 1: Japanese Patent Laid-Open No. 2004-003792

### DISCLOSURE OF THE INVENTION

### Problems that the Invention is to Solve

The driving frequency of a differential pressure control compressor has a lower limit to prevent mechanical resonance and seizing of the compressor main body. A power consumption value at the lower limit of the driving frequency is the minimum power consumption value of one differential pressure control compressor. However, the gas compression efficiency tends to decrease around the lower limit of the driving frequency of the differential pressure control compressor. Power consumption becomes large with respect to an obtained high-pressure gas volume.

When a cryopump system made up of a plurality of differential pressure control compressors and a plurality of frequency control cryopumps is operated, the minimum power consumption value is as follows. That is, the minimum power consumption value of the cryopump system is given by the sum of the minimum power consumption values of the differential pressure control compressors when the differential pressure control compressors operate at the lower limit of the driving frequency.

For this reason, even when only a small number of frequency control cryopumps run for maintenance, restoring, and the like of the frequency control cryopumps, power consumption of the cryopump system cannot be decreased so much if the cryopump system includes many differential pressure control compressors. Similarly, power consumption of the system cannot be greatly reduced even at a low consumption of high-pressure gas with a load that is low because of the standby operation of the apparatus or the like when the frequency control cryopump is operated.

A differential pressure control compressor requires an inverter, controller, pressure sensor, and the like for driving the compressor main body. The differential pressure control compressor, therefore, becomes more expensive than a compressor of normal type (to be referred to as a normal compressor) driven at a predetermined driving frequency regardless of the pressure difference between the high-pressure gas supply pipe and the low-pressure gas recovery pipe.

### Means of Solving the Problems

It is an object of the present invention to provide a cryopump system that reduces the cost and minimizes power consumption of the overall system.

To achieve the above object, according to the present invention, there is provided an exhaust system comprising
an entrapment vacuum pump equipped with a refrigerator,
a master compressor which is driven in a driving frequency band to make constant a pressure difference between gas recovered from the refrigerator via a low-pressure gas recovery pipe and compressed gas supplied to the refrigerator via a high-pressure gas supply pipe,
a first sub-compressor which is driven at a predetermined driving frequency to supply compressed gas at a first gas volume to the refrigerator via a high-pressure gas supply pipe from gas recovered from the refrigerator via a low-pressure gas recovery pipe,
a second sub-compressor which is driven at a predetermined driving frequency to supply compressed gas at a second gas volume larger than the first gas volume to the refrigerator via a high-pressure gas supply pipe from gas recovered from the refrigerator via a low-pressure gas recovery pipe, and
a controller which monitors a driving frequency of the master compressor and controls driving or a stop of the first sub-compressor and driving or a stop of the second sub-compressor, based on the driving frequency,
wherein when the driving frequency of the master compressor becomes lower than a predetermined lower limit frequency in the driving frequency band or exceeds a predetermined upper limit frequency in the driving frequency band, the controller can switch between a state in which the first sub-compressor is inactive and the second sub-compressor is driven and a state in which the first sub-compressor is driven and the second sub-compressor is inactive.

### Effect of the Invention

The present invention can reduce the cost and minimum power consumption of the overall cryopump system.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a view exemplifying the arrangement of a cryopump system according to an embodiment of the present invention;

FIG. 2 is a view exemplifying another arrangement of the cryopump system according to the embodiment of the present invention;

FIG. 3 is a view exemplifying still another arrangement of the cryopump system according to the embodiment of the present invention; and

FIG. 4 is a view exemplifying the arrangement of a conventional cryopump system.

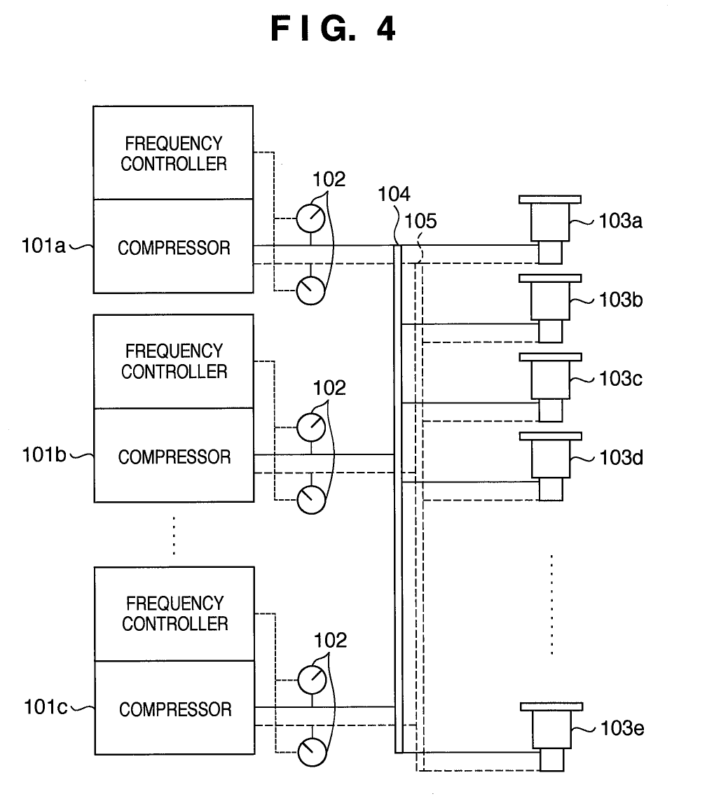

### BEST MODE FOR CARRYING OUT THE INVENTION

An embodiment of the present invention will be described in detail below. However, building elements set forth in the embodiment are merely illustrative, and the technical scope of the invention is defined by the appended claims and is not limited to an individual embodiment below.

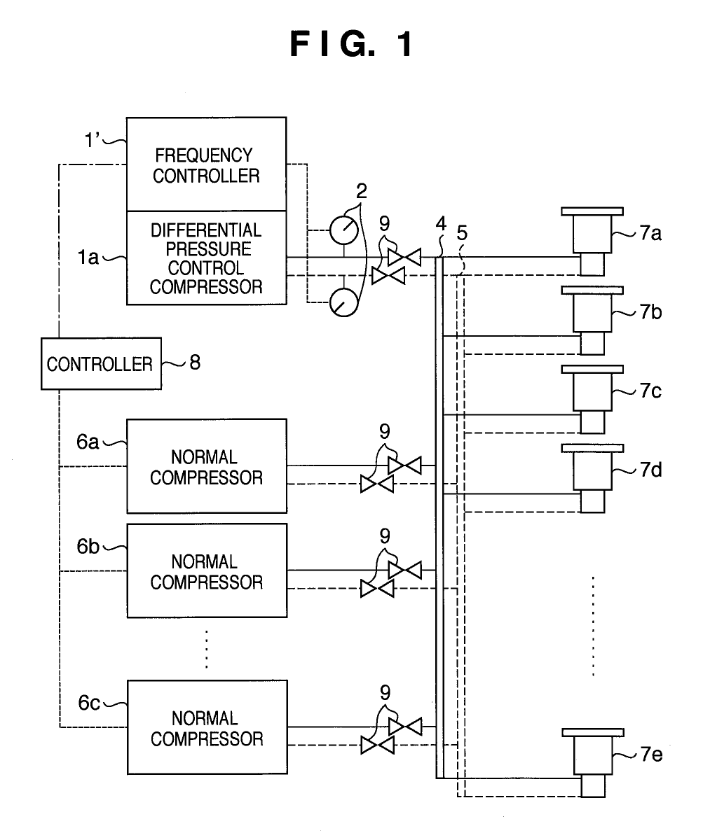

FIG. 1 is a view showing the arrangement of a cryopump system in the embodiment. The cryopump system in the embodiment includes one differential pressure control compressor 1a, a plurality of normal compressors 6a to 6c, a controller 8, and a plurality of cryopumps 7a to 7e. The differential pressure control compressor 1a, normal compressors 6a to 6c, and cryopumps 7a to 7e are connected by high-pressure gas supply pipes 4 and low-pressure gas recovery pipes 5. Valves 9 are inserted in the high-pressure gas supply pipes 4 and low-pressure gas recovery pipes 5. Pressure sensors 2 serving as detection sensors for detecting a gas pressure are attached to the high-pressure gas supply pipe 4 and low-pressure gas recovery pipe 5 connected to the differential pressure control compressor 1a. In contrast, no pressure sensor 2 is attached to the high-pressure gas supply pipes 4 and low-pressure gas recovery pipes 5 connected to the normal compressors 6a to 6c.

The cryopumps 7a to 7e according to the embodiment are entrapment vacuum pumps which exhaust gas by condensing it on an adsorption surface made of activated carbon for H₂, He, and Ne, and a cryogenic surface made of a metal for H₂O, N₂, O₂, Ar, and the like. The cryopumps 7a to 7e include refrigerators for cooling the interior of the cryopumps 7a to 7e to a cryogenic temperature. Gas compressed by the differential pressure control compressor la and normal compressors 6a to 6c is fed under pressure to the refrigerators via the high-pressure gas supply pipes 4. The gas fed under pressure via the high-pressure gas supply pipes 4 is recovered by the low-pressure gas recovery pipes 5. The cryopumps 7a to 7e are of the frequency control type. More specifically, the cryopumps 7a to 7e control the driving frequencies of valve driving motors which control the intake/exhaust cycle of the refrigerators, based on outputs from temperature sensors attached to the refrigerators. Under this control, the temperatures of the refrigerators can be kept constant, preventing excessive cooling and minimizing gas consumption of the refrigerators.

The differential pressure control compressor 1a maintains a predetermined pressure difference between the high-pressure gas supply pipe 4 and the low-pressure gas recovery pipe 5 in accordance with outputs from the pressure sensors 2 attached to the high-pressure gas supply pipe 4 and low-pressure gas recovery pipe 5. The differential pressure control compressor 1a supplies gas only at a volume necessary for the refrigerators of the cryopumps 7a to 7e. The differential pressure control compressor 1a includes a frequency controller 1′ which drives the main body of the differential pressure control compressor 1a. Maintaining a predetermined pressure difference between the high-pressure gas supply pipe 4 and the low-pressure gas recovery pipe 5 means not only keeping the pressure difference constant but also keeping it within a predetermined range.

The normal compressors 6a to 6c are driven at a predetermined driving frequency regardless of the pressure difference between the high-pressure gas supply pipe 4 and the low-pressure gas recovery pipe 5. The normal compressors 6a to 6c do not include the frequency controller 1′, unlike the differential pressure control compressor 1a, and have only a gas compression function. No pressure sensor is attached to the high-pressure gas supply pipes 4 and low-pressure gas recovery pipes 5 connected to the normal compressors 6a to 6c.

Valve-attached cooling water pipes (not shown) may be connected to the differential pressure control compressor 1a and normal compressors 6a to 6c.

The cryopump system according to the embodiment uses the differential pressure control compressor 1a as a master compressor and the normal compressors 6a to 6c as sub-compressors out of the differential pressure control compressor 1a and normal compressors 6a to 6c.

The controller 8 controls the frequency controller 1′ of the differential pressure control compressor 1a. Also, the controller 8 monitors the driving frequency of the differential pressure control compressor 1a serving as a master compressor, and controls driving of the normal compressors 6a to 6c based on the driving frequency. The controller 8 can control to open/close the valves 9 in synchronism with the operations of the differential pressure control compressor 1a and normal compressors 6a to 6c. More specifically, the controller 8 opens the valves 9 corresponding to the differential pressure control compressor la and normal compressors 6a to 6c in synchronism with the start of operation of these compressors. The controller 8 closes the valves 9 corresponding to the differential pressure control compressor 1a and normal compressors 6a to 6c in synchronism with the stop of operation of these compressors. Further, the controller 8 can control the valve opening/closing operations of the cooling water pipes of the differential pressure control compressor 1a and normal compressors 6a to 6c in accordance with the operating states of these compressors. A significant energy saving effect can be expected by optimizing a cooling water circulation path for each compressor. The controller 8 having these functions may be installed separately or incorporated in the master compressor. The controller of the cryopump may have these functions.

A method of controlling the cryopump system according to the embodiment will be described.

The controller 8 checks the load on all the differential pressure control compressor la and normal compressors 6a to 6c based on the driving frequency value of the master compressor (differential pressure control compressor 1a).

When the output value of the driving frequency of the master compressor has reached a predetermined value, for example, an upper limit ±30%, the controller 8 controls to start operating one sub-compressor subjected to driving control among one or a plurality of inactive sub-compressors (normal compressors) 6a to 6c. In synchronism with this, the controller 8 controls to open the valve 9 corresponding to the sub-compressor that has started operating.

To the contrary, when the output value of the driving frequency of the master compressor has reached a predetermined value, for example, a lower limit ±30%, the controller 8 controls to stop operating one sub-compressor subjected to driving control among one or a plurality of active sub-compressors (normal compressors) 6a to 6c. In synchronism with this, the controller 8 controls to close the valve 9 corresponding to the sub-compressor that has stopped, in order to prevent gas from passing through the inactive compressor main body.

As described above, the cryopump system in the embodiment uses only one differential pressure control compressor 1a among a plurality of compressors, and adopts the normal compressors 6a to 6c as the remaining compressors. The controller 8 controls one differential pressure control compressor 1a as a master compressor based on the driving frequency. Based on the driving frequency of the master compressor, the controller 8 monitors the load on the master compressor (differential pressure control compressor 1a), and individually controls driving of the normal compressors 6a to 6c. The normal compressors 6a to 6c, which are driven at a predetermined driving frequency, serve as sub-compressors, and driving of them is individually controlled by the controller 8 based on the driving frequency of the differential pressure control compressor 1a. That is, the sub-compressors (normal compressors 6a to 6c) are individually controlled to start or stop operating based on the driving frequency of the differential pressure control compressor 1a.

A differential pressure control compressor generally requires an inverter, control circuit, pressure sensor, and the like for driving the compressor main body. The differential pressure control compressor becomes more expensive than a normal compressor requiring none of these components. However, the cryopump system according to the embodiment uses only one differential pressure control compressor, and can reduce the cost of the whole system.

When the system includes many differential pressure control compressors, power consumption of the system cannot be reduced satisfactorily. However, the system of the present invention basically adopts only one differential pressure control compressor, operates or stops a normal compressor, as needed, and thus can reduce power consumption of the overall system. That is, the cryopump system according to the present invention can suppress the minimum power consumption value of the whole system regarding the differential pressure control compressor to power consumption of one differential pressure control compressor (master compressor) at the lower limit of the driving frequency regardless of the number of connected compressors. At a low load, this cryopump system can attain a more significant energy saving effect than that of a conventional system.

To achieve a more efficient operation, the variable range of the gas discharge volume depending on that of the driving frequency of a differential pressure control compressor desirably has a width exceeding the gas discharge volume of one normal compressor.

In this system, the valves 9 are inserted in the high-pressure gas supply pipes 4 and low-pressure gas recovery pipe 5 connected to the respective compressors 1a and 6a to 6c. Even if trouble occurs in a given compressor, only the valve 9 corresponding to the compressor is closed, and the compressor can be removed from the system and exchanged without stopping the remaining compressors.

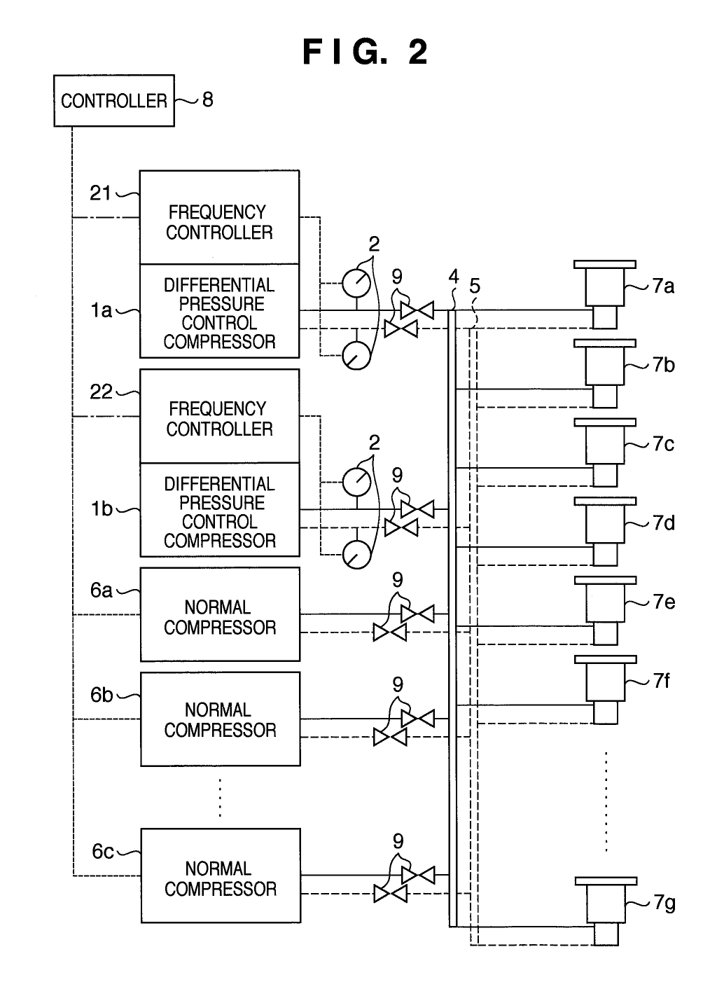

FIG. 2 is a view exemplifying another arrangement of the cryopump system in the embodiment. If the variable range of the gas discharge volume in the differential pressure control compressor is insufficient, the number of differential pressure control compressors may be increased, like differential pressure control compressors 1a and 1b in FIG. 2. In this arrangement, the variable range of the gas discharge volume depending on that of the driving frequency becomes larger by the differential pressure control compressor 1b than that using only the differential pressure control compressor 1a. Accordingly, the variable range of the gas discharge volume can be widened.

The arrangement shown in FIG. 2 uses two differential pressure control compressors. However, the number of differential pressure control compressors suppressed is small with respect to the number of compressors of the whole system. Further, if one differential pressure control compressor tries to cope with the entire system though the variable range of the gas discharge volume and is insufficient, no efficient operation can be done after all. In this case, therefore, a plurality of differential pressure control compressors are preferably used. Even with the arrangement as shown in FIG. 2, the present invention can reduce power consumption of the entire system and its necessary cost.

The controller 8 shown in FIG. 2 can control a frequency controller 21 of the differential pressure control compressor 1a and a frequency controller 22 of the differential pressure control compressor 1b. In the arrangement shown in FIG. 2, the differential pressure control compressors 1a and 1b function as master compressors. The controller 8 monitors the driving frequencies of the differential pressure control compressors 1a and 1b serving as master compressors. When the driving frequency of at least either the differential pressure control compressor 1a or 1b falls within a predetermined range of the upper limit, the controller 8 controls an inactive sub-compressor to start operating, as described in the embodiment of FIG. 1. In contrast, when the driving frequency of either the differential pressure control compressor 1a or 1b falls within a predetermined range of the lower limit, the controller 8 controls an active sub-compressor to stop operating. After that, the controller 8 controls the differential pressure control compressors 1a and 1b to maintain a predetermined pressure difference between the high-pressure gas supply pipe and the low-pressure gas recovery pipe.

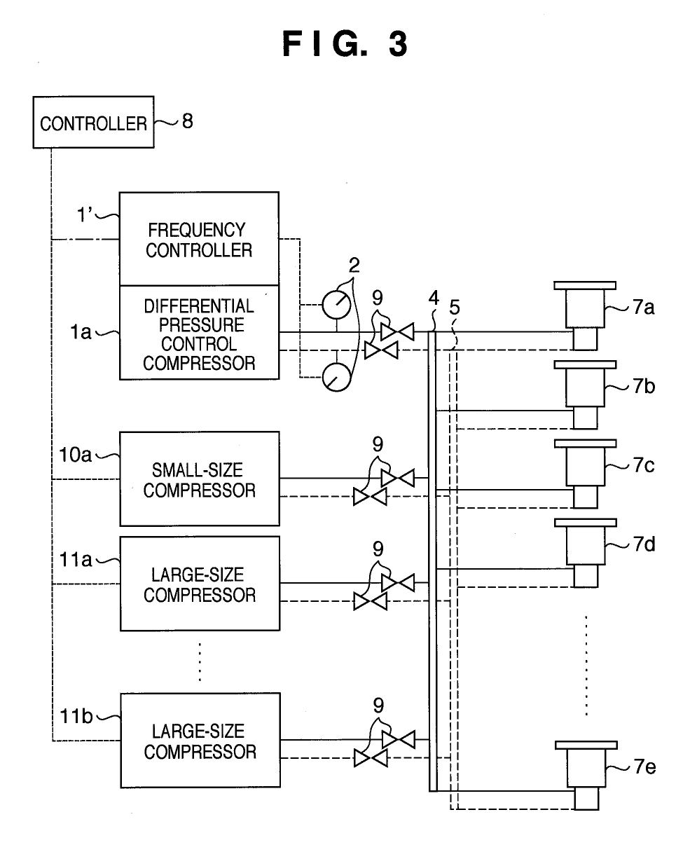

FIG. 3 is a view exemplifying still another arrangement of the cryopump system in the embodiment. In the cryopump system shown in FIG. 3, a plurality of sub-compressors are formed from a normal compressor of small size (small-size normal compressor 10a) and normal compressors of large size (large-size normal compressors 11a and 11b). The small-size normal compressor 10a is smaller in gas discharge volume than the large-size normal compressors 11a and 11b.

This arrangement can perform the following control when gas consumption of the cryopumps 7a to 7e decreases and the driving frequency of the differential pressure control compressor 1a becomes lower than the lower limit or a predetermined value around the lower limit.

When the small-size normal compressor 10a runs, the controller 8 controls the small-size normal compressor 10a to stop operating.

In contrast, when the small-size normal compressor 10a stands still, the controller 8 controls either the large-size normal compressor 11a or 11b to stop, and the small-size normal compressor 10a to start operating. Even if the driving frequency of the differential pressure control compressor still falls within a predetermined range of the lower limit, the controller 8 further stops the small-size normal compressor 10a or the large-size normal compressor.

This arrangement can execute the following control when gas consumption of the cryopumps 7a to 7e increases and the driving frequency of the differential pressure control compressor 1a exceeds the upper limit or a predetermined value around the upper limit.

When the small-size normal compressor 10a stands still, the controller 8 controls the small-size normal compressor 10a to start operating.

To the contrary, when the small-size normal compressor 10a runs, the controller 8 controls the large-size normal compressor to start operating and the small-size normal compressor 10a to stop operating. Even if the driving frequency of the differential pressure control compressor still falls within a predetermined range of the upper limit, the controller 8 controls the small-size normal compressor 10a or the large-size normal compressor 11b to start operating.

In the arrangement of FIG. 3, an efficient operation can be done as long as the variable range of the gas discharge volume of the differential pressure control compressor 1a exceeds a larger discharge volume out of the gas discharge volume of the small-size normal compressor 10a and a difference of the gas discharge volume of the small-size normal compressor 10a from that of one large-size normal compressor (11a or 11b).

In the present invention, normal compressors serving as sub-compressors are not limited to the two, small- and large-size types. That is, normal compressors suffice to include compressors with gas discharge volumes different from each other. Various kinds of compressors such as a smaller-, larger-, and middle-size ones can be combined.

A cryopump has been exemplified in the arrangements of FIGS. 1, 2, and 3. However, the same effects as those described above can be expected even using a water trap instead of the cryopump. A combination of the cryopump and water trap can also achieve the same effects as those described above.

A preferred embodiment of the present invention has been described with reference to the accompanying drawings. However, the present invention is not limited to the aforementioned embodiment, and can be properly modified without departing from the scope of the invention defined by the appended claims.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-220881, filed Aug. 28, 2007, which is hereby incorporated by reference herein in its entirety.

1. An exhaust system comprising:
an entrapment vacuum pump equipped with a refrigerator;
a master compressor which is driven in a driving frequency band to make constant a pressure difference between gas recovered from the refrigerator via a low-pressure gas recovery pipe and compressed gas supplied to the refrigerator via a high-pressure gas supply pipe;
a first sub-compressor which is driven at a predetermined driving frequency to supply compressed gas at a first gas volume to the refrigerator via a high-pressure gas supply pipe from gas recovered from the refrigerator via a low-pressure gas recovery pipe;
a second sub-compressor which is driven at a predetermined driving frequency to supply compressed gas at a second gas volume larger than the first gas volume to the refrigerator via a high-pressure gas supply pipe from gas recovered from the refrigerator via a low-pressure gas recovery pipe; and
a controller which monitors a driving frequency of said master compressor and controls driving or a stop of said first sub-compressor and driving or a stop of said second sub-compressor, based on the driving frequency,
wherein when the driving frequency of said master compressor becomes lower than a predetermined lower limit frequency in the driving frequency band or exceeds a predetermined upper limit frequency in the driving frequency band, said controller can switch between a state in which said first sub-compressor is inactive and said second sub-compressor is driven and a state in which said first sub-compressor is driven and said second sub-compressor is inactive.

2. (canceled)

3. The exhaust system according to claim 1, wherein
when the driving frequency of said master compressor becomes lower than the predetermined lower limit frequency in the driving frequency band and said first sub-compressor is inactive, said controller controls to stop said second sub-compressor and drive said first sub-compressor, and
when the driving frequency of said master compressor exceeds the predetermined upper limit frequency in the driving frequency band and said first sub-compressor is driven, said controller controls to drive said second sub-compressor and stop said first sub-compressor.

4. The cryopump exhaust system according to claim 1, wherein
said master compressor is a differential pressure control compressor driven to maintain, to a value within a predetermined range, a pressure difference between a pressure value detected by a pressure gauge attached to the high-pressure gas supply pipe and a pressure value detected by a pressure gauge attached to the low-pressure gas recovery pipe, and
said controller controls the driving frequency of said master compressor based on the pressure difference obtained by the pressure gauges.

5. The exhaust system according to claim 1, wherein valves are inserted in the high-pressure gas supply pipe and low-pressure gas recovery pipe of said master compressor and the high-pressure gas supply pipes and low-pressure gas recovery pipes of said first and second said sub-compressors.

6. The exhaust system according to claim 5, wherein said controller opens the valve for supplying compressed gas to said first or second sub-compressor in synchronism with a start of operation of said first or second sub-compressor, and closes the valve for supplying gas to said first or second sub-compressor in synchronism with a stop of operation of said first or second sub-compressor.

7. (canceled)

8. The exhaust system according to claim 1, wherein a variable range of a discharge volume of the compressed gas in the driving frequency band of said master compressor has a width exceeding a larger discharge volume out of a discharge volume of said first sub-compressor and a difference of the discharge volume of said first sub-compressor from a discharge volume of said second sub-compressor.

9. The exhaust system according to claim 1, wherein said entrapment vacuum pump equipped with the refrigerator includes a cryopump or a water trap.

10. The exhaust system according to claim 9, wherein the cryopump is a frequency control type capable of controlling a driving frequency of the refrigerator.
